(19) United States
(12) Patent Application Publication
(10) Pub. No.: US 2007/0143122 A1
(43) Pub. Date: Jun. 21, 2007

(54) Business method for correlating product reviews published on the world wide Web to provide an overall value assessment of the product being reviewed

(76) Inventors: Lane Thomas Holloway, Pflugerville, TX (US); Eric Thomas Lambert, Wappingers Falls, NY (US); Nadeem Malik, Austin, TX (US); Benjamin John Steele JR., Newburgh, NY (US); Michael Ellett Weissinger, Austin, TX (US)

Correspondence Address: IBM CORPORATION, PO BOX 12195, DEPT YXSA, BLDG 002, RESEARCH TRIANGLE PARK, NC, 27709, US

(21) Appl. No.: 11/295,299

(22) Filed: Dec. 6, 2005

(51) Int. Cl. G06Q 99/00

(52) U.S. Cl. 705/1

(57) ABSTRACT

A searching method in the Internet that correlates publicly available product reviews for products by initially predetermining a set of review terms indicative of a favorable review and also predetermining a set of review terms indicative of an unfavorable review. From a requesting station, databases in the Internet are searched for the product reviews as follows. Product reviews are distinguished from other documents mentioning the product that may also be in the searched databases. Each distinguished product review is then analyzed using the predetermined review terms indicative of favorable reviews and predetermined review terms indicative of unfavorable reviews. An overall determination is made as to whether each individual product review was favorable, unfavorable or balanced.

### TECHNICAL FIELD

The present invention relates to searching in the World Wide Web (Web), and particularly to “data mining” in the Web involving a method for correlating published reviews on selected products through Web searching.

### BACKGROUND OF RELATED ART

The past generation has been marked by a technological revolution driven by the convergence of the data processing industry with the consumer electronics industry. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet (used interchangeably herein), that had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Internet and equipped with a Web browser has led to the development of a type of “Web data mining” in which combinations of Web searches are used to relate fragments of data that individually appear to be innocent and non-confidential to those who made the data available; but, when pieced together, can be very valuable in what is revealed about the publishers of data and their products.

In a business environment, all companies and organizations are very concerned about how their products and the products of competitors are being rated in their marketplace. Also, product reviews are of interest to potential purchasers of and investors in selected products. The Web or Internet offers access to product reviews along with a great deal of data on the product technology and background. When someone wishes to get product review information on a product to be purchased or a product being sold, a standard approach would be to search the Web for all reviews on a particular product. The interested party then reads all of the reviews and decides which reviews are more trustworthy. The party then makes decisions based upon the reviews that he has read. This process is quite time consuming. It usually requires several individual searches. Also, in reviewing the articles and publications on the product, the user has to consume time in at least browsing through articles mentioning the product that do not review products, technical descriptions that are not reviews and marketing information. If a user tries to conventionally search a well known product, such as an automotive product, the search result may list thousands of articles.

### SUMMARY OF THE PRESENT INVENTION

The present invention provides a proposed solution for the above problems in searching for product reviews. The invention provides a correlated result that presents the found publications in such a mode that a user may readily determine which product reviews will satisfy his requirements. The search results also provide overall evaluations of each product review, as well as comparative review summaries that assess the individual product reviews with respect to each other.

The invention is implemented by a searching method in a public network, such as the Web or Internet, that correlates publicly available product reviews for products by initially predetermining a set of review terms indicative of a favorable review and also predetermining a set of review terms indicative of an unfavorable review. Then, from a requesting display station, databases accessible through said network are searched for the product reviews as follows.

Product reviews are distinguished from other documents mentioning the product that may also be in the searched databases. Each distinguished product review is then analyzed using the predetermined review terms indicative of favorable reviews and predetermined review terms indicative of unfavorable reviews. At this point, an overall determination is made as to whether each individual product review was favorable or unfavorable or balanced. The searches are preferably conducted using Web crawler processes that will hereinafter be discussed in greater detail.

In accordance with an aspect of the invention, there is included the steps of assigning to each of said predetermined review terms a favorability weight indicative of the favorable or unfavorable level of the term. Also, there may be determined for each product review an overall favorability or unfavorability numerical value rating based analysis criteria including said weights of and the frequency of usage of said predetermined terms. The invention also enables the dynamic addition of further review terms to said predetermined sets of review terms during said searching.

In another aspect of the invention, the searching may be carried out by a Web service provider serving the individual Web display stations, and this service provider may provide overall product ratings based upon a correlation of all product reviews for a product. This service provider may maintain a database including said overall product ratings for a plurality of said products, and can thus provide a plurality of these overall product ratings to requesting display stations on the Web.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion, i.e. a server computer connected to a Web portion, to illustrate how the present invention provides the searches for product reviews from databases connected to the Web;

FIG. 2 is a block diagram of a data processing system including a central processing unit and network connections via a communications adapter that is capable of functioning both as a server computer and a client display station in the Web network of the present invention;

FIG. 3 is an illustrative interactive display showing an illustrative page of a Web document to illustrate how the present invention provides a searched for product review in which both predetermined review terms indicative of favorable and unfavorable reviews are highlighted;

FIG. 4 is an illustrative interactive display showing an illustrative comparative product review ratings display panel that may be provided from a Web service provider conducting the product review searches of the present invention;

FIG. 5 is an illustrative flowchart describing the product review searching and analysis of the present invention; and

FIG. 6 is a flowchart of an illustrative run of the program set up in FIG. 5.

### DETAILED DESCRIPTION OF THE PREFERRED EMBODIMENT

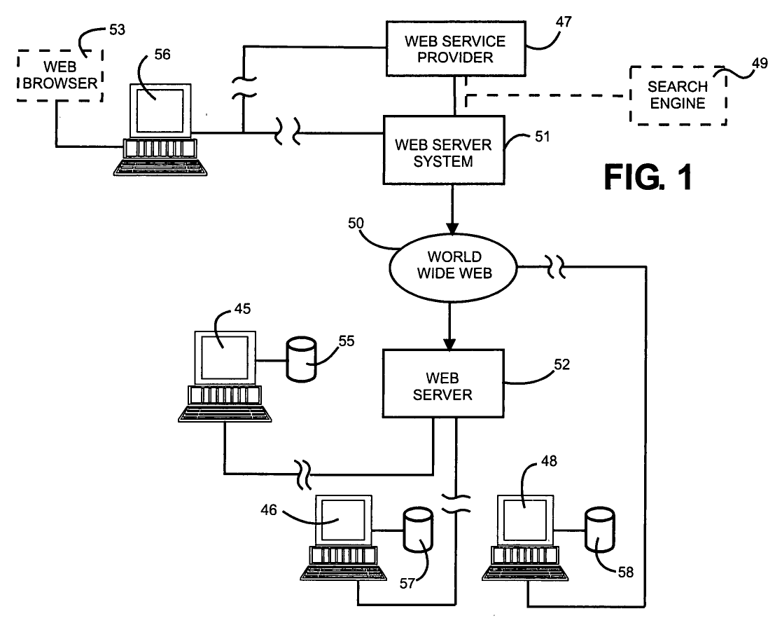

Referring to FIG. 1, a generalized example of the practice of the present invention involves a generalized portion of the Web that serves as the illustrative communication network in this embodiment of the present invention. First, it should be helpful to understand from a general perspective, the various elements and methods that may be related to the present invention. Since the present invention is applicable to Web markup language hypertext documents formed by multiple content portions, respectively, from multiple sources on the Web, an understanding of the Web and its operating principles would be helpful. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation.

Web documents are conventionally implemented in a markup language, e.g. HTML, which is described in detail in the text, Just Java, 2nd Edition, Peter van der Linden, Sun Microsystems, 1997, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, and Chapter 20, pp. 455-494, on the Microsoft Internet Explorer; and Chapter 21, pp. 495-512, covering Lynx, Opera and other browsers.

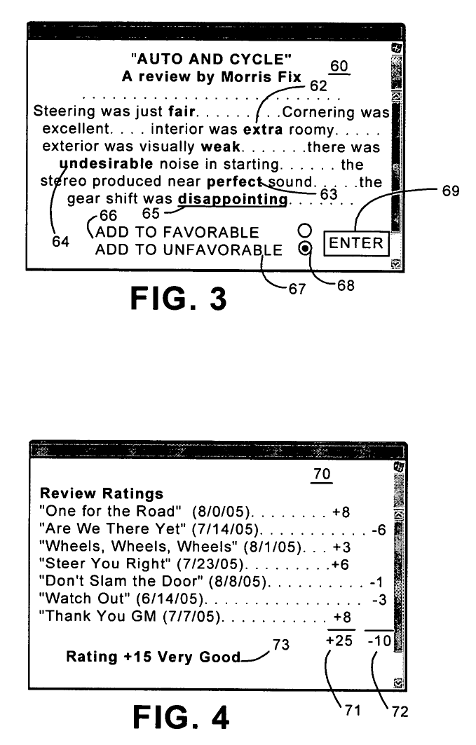

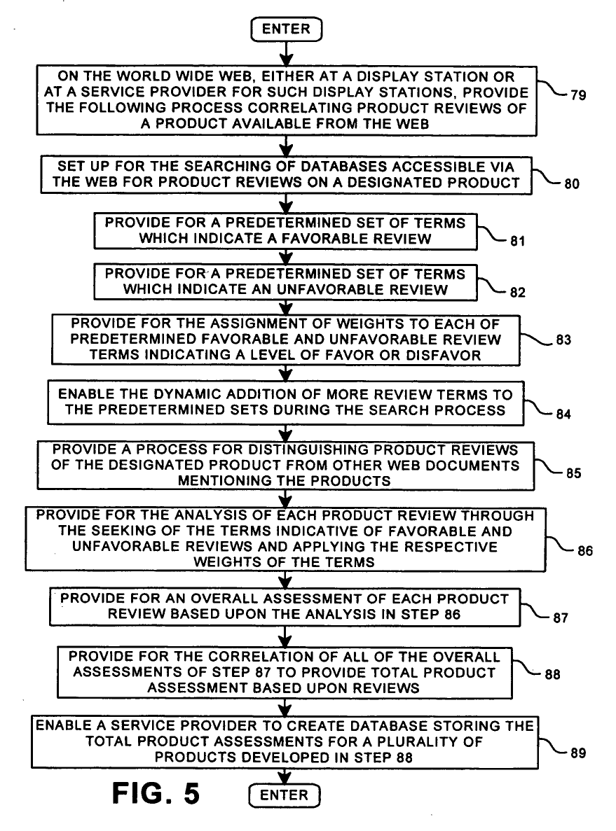

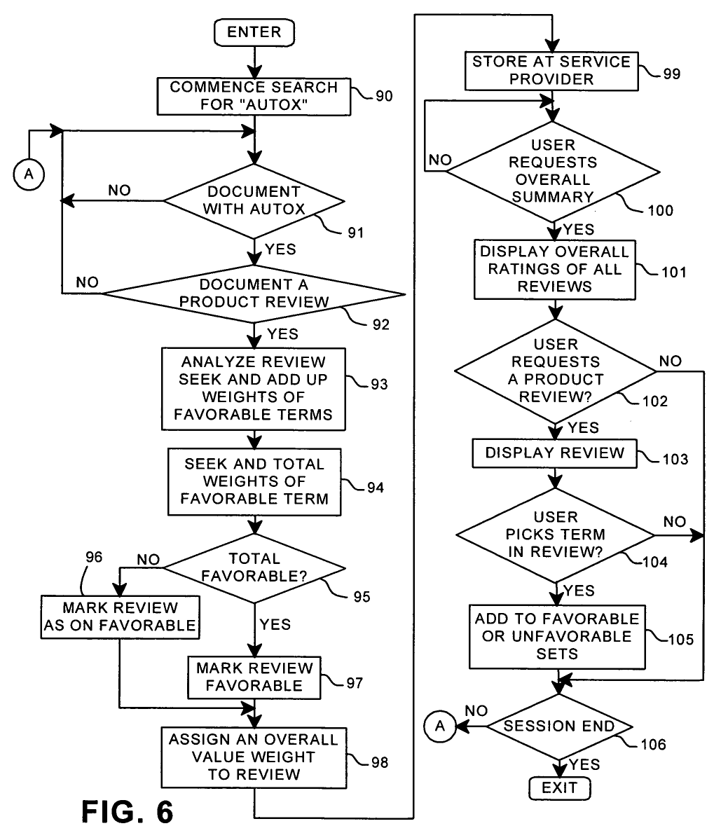

In light of this background, reference is made to FIG. 1 showing a portion of the Web or Internet set up for searching and analysis of product reviews. Computer station 56 serves as a typical Web display station for receiving or sending Web documents, including search documents and results. As will be described hereinafter with respect to the display interfaces of FIGS. 3 and 4 and the programs of FIGS. 5 and 6, the Web documents are displayed on computer display station 56. Under the control of any conventional Web browser 53 in computer 56, the product review searches, which will hereinafter be described in greater detail, are carried out utilizing a search engine 49, and operating via a conventional Web server system 51 via the Web 50 and through respective Web server 52 to any of the multiple content from any of databases 55, 57 and 58, respectively, associated with Web document sites or sources represented by stations 45, 46 and 48.

It will also be understood that instead of any conventional Web server, system 51 may be replaced by a server system of a service provider 47 that will conventionally perform this Web server function, along with other Web service provider functions to be subsequently described in greater detail.

The search engines 49 are described in the above-mentioned: Internet: The Complete Reference, Milleniun Edition, pages 395 and 522-535, search engines use keywords and phrases to query the Web for desired subject matter. Usually the keywords are combined with some of the basic Boolean operators, i.e. AND, OR and NOT, in designing Web queries. Each search engine has its own well developed syntax or rules for combining such Boolean operators with the keywords to conduct the searches. The search engine usually uses a search agent called a “spider” or “crawler” that looks for information on Web pages. Such information is indexed and stored in a vast database. In carrying out its search, the search engine looks through the database for matches to keywords subject to the engine syntax. In the present invention, the search engine then presents to the user a list of the Web pages it had determined to have the job listings sought in the requested query that contain job listings including the competitors' name or products. Some significant search engines are: AltaVista, Infoseek, Lycos, Magellan, Webcrawler and Yahoo.

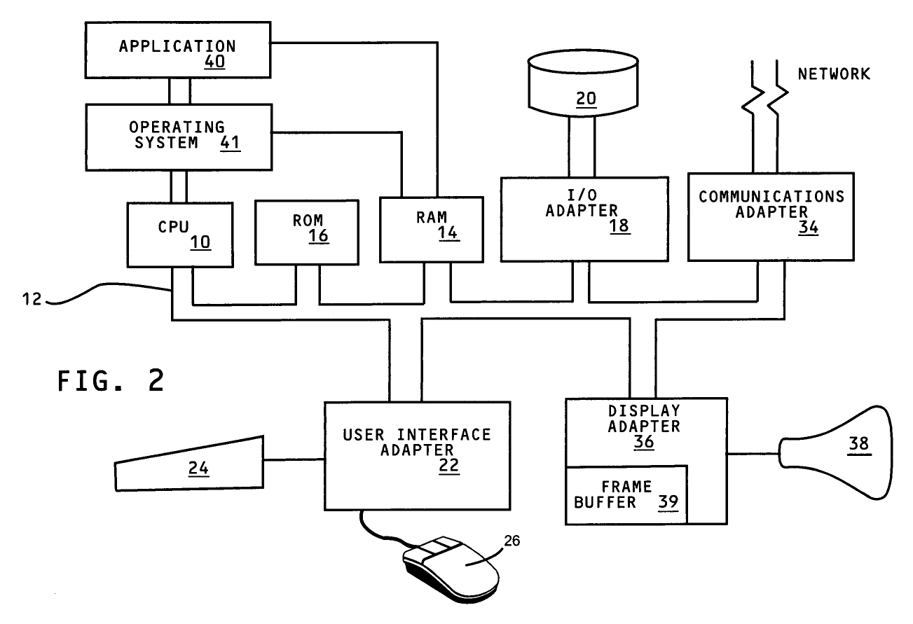

Referring to FIG. 2, a typical data processing unit is shown that may function as the network display stations used for receiving the Web document product reviews and product review assessments, as well as for the Web servers shown in FIG. 1. A central processing unit (CPU) 10, such as one of the PC microprocessors or workstations available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsMe™ or Windows 2000™, as well as UNIX and other IBM AIX operating systems. Application programs 40, controlled by the system, are moved into and out of the main memory Random Access Memory (RAM) 14. These programs include search programs of the present invention. These functions will be described hereinafter in combination with conventional Web browsers (browsers 53, FIG. 1) at Web display stations 56 (FIG. 1), such as Microsoft's Internet Explorer™.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network. I/O devices are also connected to system bus 12 via user interface adapter 22 and display adapter 36. Keyboard 24 and mouse 26 are all interconnected to bus 12 through user interface adapter 22. It is through such input zadevices that the user at the Web display stations may interactively relate to the Web server programs for providing the searching and search documents of the present invention.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

FIG. 3 is an illustrative interactive display showing an illustrative page of a Web document to illustrate how the present invention provides a searched for product review in which both predetermined review terms indicative of favorable and unfavorable reviews are highlighted. A product review article is shown in window 60. The predetermined terms indicative of favorable and unfavorable reviews are highlighted in bold letters. Let us assume that the highlighting was the result of the process of the present invention operating with the following sets of predetermined review terms:

FAVORABLE: good, excellent, perfect, flawless, exact, exemplary, ideal, suitable, qualified, reliable, safe, . . . extra.

UNFAVORABLE: bad, faulty, poor, adverse, harmful, undesirable, weak . . . slow.

The terms: weak and undesirable 64 from the unfavorable predetermined review terms show up in the article, as well as the terms perfect 63 and extra 62 from the favorable predetermined review terms. Also, two terms “fair” and “disappointing” 65 are not on any of the lists. When such additional terms show up in an article being reviewed, the user is enabled to add the term to one of the predetermined review terms lists. In the present example the user has pointed to and, thus, highlighted the term “disappointing” 65. When a new term is so highlighted, the user has the option of selecting either “Add to Favorable” 66 or “Add to Unfavorable” 67 by clicking on the associated entry circle 68. In the present example, the user has selected to add “disappointing” 65 to the set of predetermined Unfavorable Review terms.

The evaluations of the product review articles are usually carried out transparently to the user. In evaluating the favorable and unfavorable aspects of the product reviews, the review terms may be individually weighted. For example, with respect to favorable review terms, “perfect” would be given a greater predetermined weight than “good” or with respect to unfavorable review terms, “undesirable” would be given a greater weight than “weak”.

As previously mentioned, and particularly when a Web service provider is involved, a summary of several review articles may be provided to a user at a receiving station as shown in FIG. 4, display screen 70 wherein each review article title is given a positive or favorable review overall weight toward the “Afterglow” product, or a negative or unfavorable review overall weight. The total weights for all of the articles both positive 71 and negative 72 are added to provide an overall product rating 73.

Now, with reference to FIGS. 5 and 6 there will be described a process implemented by the present invention in conjunction with the flowcharts of these figures. FIG. 5 is a flowchart showing the development of a process according to the present invention for correlating product reviews accessed from the Web for a selected product. The process to be described may be implemented at a receiving display station, usually in association with the Web browser. Alternatively, and probably most effectively in a business environment, the process may be implemented in the service provider serving a plurality of such Web stations, step 79. The procedure is set up for the searching of databases accessible via the Web for product reviews on a designated product, step 80. Provision is made for the setting up of a set of predetermined terms, each of which indicate a favorable review, step 81. Likewise, provision is made for the setting up of a set of predetermined terms, each of which indicate an unfavorable review, step 82. Provision is also made for the assignment of weights to each of the predetermined favorable and unfavorable review terms. These weights indicate a level of favor or disfavor, step 83. There is the further enablement of the dynamic addition of more selected review terms to the predetermined sets during the search process, step 84. A process should be provided for distinguishing product reviews of the designated product from other Web documents mentioning the product, step 85. Provision is made for the analysis of each product review by seeking the terms indicative of favorable and unfavorable reviews and applying respective weights to the terms, step 86. Provision is made, step 87, for an overall assessment of each product review based upon the analysis of step 86. Provision is also made, step 88, for the correlation of all of the overall assessments of step 87 to provide a total product assessment based upon reviews. A service provider is enabled, step 89, to create a database storing the total product assessments for a plurality of the products developed in step 88.

An illustrative run of the process set up in FIG. 5 will now be described with respect to FIG. 6. A search is commenced for the product “Autox”, a fictional automobile fuel additive, step 90. As the search progresses through the “Spider” or “Crawler”, determinations are made as to whether documents with “Autox” are located, step 91. If No, searching continues. If Yes, a further determination is made as to whether the document is a product review, step 92. There may be many anticipated algorithms that can distinguish a review from another article mentioning the product. For example, if the terminology in the article does contain a specified count of the predetermined favorable and unfavorable review terms, e.g. review terms appear at least twice, then the article found is not likely to be a review. With a No decision in step 92, the search continues, step 91. If the determination in step 92 is Yes, this is a product review, the review is analyzed and the weights of favorable, step 93, and unfavorable, step 94, are added up. Then a determination is made, step 95, as to whether the total is favorable. If No, the review is designated as an unfavorable review, step 96. If Yes, the review is designated as a favorable review, step 97. Then, after either of steps 96 and 97, an overall net value weight, negative or positive, is assigned to the review, step 98. In the present example where a Web service provider is involved in the searching, the results of step 98 are stored at the service provider, step 99. And a determination is awaited in step 100 as to whether a user has requested an overall result summary of all of the product reviews found. If Yes, then, step 101, the reviews and their individual ratings, as well as the overall ratings, are displayed as illustrated in FIG. 4. At this point, or at any stage in the search, it may be determined that a user has requested to have a particular review displayed, step 102. If Yes, the requested review (FIG. 3) is displayed, step 103. At any point in the ongoing search, the user may request, step 100, an overall display of the product reviews located thus far, and the display screen of FIG. 4 will be displayed, from which the user may select to have a particular review displayed. The selected product review, the display screen of FIG. 3, will be displayed. At this point, as previously described with respect to FIG. 3, the user may select Yes for step 104, a new review term to be added to the predetermined sets of either favorable or unfavorable terms and the search will continue. As the searching continues, determinations are made, step 106, as to whether the search is ended. If Yes, the search is exited. If No, the process is branched via “A” back to step 91, and searching continues.

Although certain preferred embodiments have been shown and described, it will be understood that many changes and modifications may be made therein without departing from the scope and intent of the appended claims.

What is claimed is:

1. In a public network of communicating computer display stations, a business method for correlating publicly available product reviews for products comprising:
predetermining a set of review terms indicative of a favorable review;
predetermining a set of review terms indicative of an unfavorable review;
from a requesting display station, searching databases accessible through said network for said product reviews;
distinguishing product reviews from other available documents mentioning said products from said databases;
analyzing each distinguished product review using review terms indicative of favorable reviews and each distinguished product review using review terms indicative of unfavorable reviews; and
making an overall determination as to whether each product review was favorable or unfavorable.

2. The business method of claim 1 wherein said network is the World Wide Web.

3. The business method of claim 2 wherein said step of analyzing each product review provides for each product review a rating selected from the group consisting of a favorable review, an unfavorable review and a balanced review.

4. The business method of claim 2 wherein databases on the World Wide Web are searched using a Web crawler process.

5. The business method of claim 3 further including the steps of assigning to each of said predetermined review terms a favorability weight indicative of the favorable or unfavorable level of the term.

6. The business method of claim 5 further including the step of determining for each product review an overall favorability or unfavorability numerical value rating based analysis criteria including said weights of and the frequency of usage of said predetermined terms.

7. The business method of claim 6 further including the step of enabling the dynamic addition of further review terms to said predetermined sets of review terms during said searching.

8. The business method of claim 6 wherein a Web service provider performs said requested searches for requesting display stations.

9. The business method of claim 8 wherein said Web service provider provides overall product ratings based upon a correlation of all product reviews for a product.

10. The business method of claim 9 wherein said Web service provider:
maintains a database including said overall product ratings for a plurality of said products; and
is enabled to provide a plurality of said overall product ratings to requesting display stations on the Web.

11. A computer program having code recorded on a computer readable medium for correlating publicly available product reviews for products in a public network of communicating computer display stations comprising:
means for predetermining a set of review terms indicative of a favorable review;
means for predetermining a set of review terms indicative of an unfavorable review;
means for searching, from a requesting display station, databases accessible through said network for said product reviews;
means for distinguishing product reviews from other available documents mentioning said products from said databases;
means for analyzing each distinguished product review using review terms indicative of favorable reviews and each distinguished product review using review terms indicative of unfavorable reviews; and
means for making an overall determination as to whether each product review was favorable or unfavorable.

12. The computer program of claim 11 wherein said network is the World Wide Web.

13. The computer program of claim 12 wherein said means for analyzing each product review provides for each product review a rating selected from the group consisting of a favorable review, an unfavorable review and a balanced review.

14. The computer program of claim 12 wherein the means for searching databases on the World Wide Web use a Web crawler program.

15. The computer program of claim 13 further including means for assigning to each of said predetermined review terms a favorability weight indicative of the favorable or unfavorable level of the term.

16. The computer program of claim 15 further including means for determining for each product review an overall favorability or unfavorability numerical value rating based analysis criteria including said weights of and the frequency of usage of said predetermined terms.

17. The computer program of claim 6 further including means for enabling the dynamic addition of further review terms to said predetermined sets of review terms during said searching.

18. The computer program of claim 16 wherein a Web service provider performs said requested searches for requesting display stations.

19. The computer program of claim 18 wherein said Web service provider provides overall product ratings based upon a correlation of all product reviews for a product.

20. The computer program of claim 19 wherein said Web service provider:
maintains a database including said overall product ratings for a plurality of said products; and
is enabled to provide a plurality of said overall product ratings to requesting display stations on the Web.
